(19) United States
(12) Patent Application Publication
(10) Pub. No.: US 2025/0003322 A1
(43) Pub. Date: Jan. 2, 2025

(54) ACID FRACTURING TREATMENT OF A FORMATION

(71) Applicant: SCHLUMBERGER TECHNOLOGY CORPORATION, Sugar Land, TX (US)

(72) Inventors: Alexey Vladimirovich ALEKSEEV, Novosibirsk (RU); Rostislav Vladimirovich ROMANOVSKII, Novosibirsk (RU); Denis Yurievich EMELYANOV, Esbjerg (DK); Dmitry Sergeevich KUZNETSOV, Sugar Land, TX (US); Galina Gennadievna LYAPUNOVA, Novosibirsk (RU); Olga Vladimirovna NEVVONEN, Koltsovo (RU); Maxim Grigorievich IVANOV, Novosibirsk (RU)

(21) Appl. No.: 18/706,611

(22) PCT Filed: Nov. 1, 2021
(86) PCT No.: PCT/RU2021/000476

§ 371 Date: May 1, 2024

(51) Int. Cl. E21B 43/27; C09K 8/72; E21B 43/267

(52) U.S. Cl. CPC E21B 43/27; C09K 8/72; E21B 43/267; E21B 2200/20

(57) ABSTRACT

A subterranean well may be stimulated by first providing a plurality of candidate stimulation treatments that comprise injecting an acid-containing hydraulic fracturing fluid, wherein the candidate stimulation treatments are compatible with the formation characteristics. For each candidate stimulation treatment, laboratory testing is performed to measure interactions between the hydraulic fracturing fluid and the formation to be stimulated. The laboratory testing results are then entered into a computational model that calculates fluid-formation interaction parameters. The interaction parameters are used to design a hydraulic acid fracturing treatment that will provide maximum well productivity. The designed hydraulic acid fracturing treatment is then performed.

### BACKGROUND

The statements in this section merely provide background information related to the present disclosure and may not constitute prior art.

This relates to hydrocarbon production, and in particular to hydrocarbon production using well stimulation techniques.

For some wells and formations, the quantity of hydrocarbons which may be produced from a reservoir, or the rate at which such hydrocarbons may be produced, may be improved by stimulation of the well or reservoir using various techniques. Example techniques include high-pressure injection of fluids such as water, gels, acids or slurries including fibers or proppants. This practice is generally referred to as hydraulic fracturing and it benefits from a high conductivity of fractures remained after fracture closing.

Typically, an aim of such stimulation is to increase the conductivity of the formation to hydrocarbon fluids, such that fluids can more easily pass through the formation to the wellbore for production. For example, pressurized fluid may create and physically widen fractures in the formation, which may be held open by proppant. Similarly, acidic fluids may etch surfaces in the formation due to chemical dissolution of the reservoir rock, creating additional clearance for fluid flow during well production. This method is known as acid fracturing.

Based on the composition of the reservoir rock, reservoir fluid, stimulation fluids, and physical conditions downhole, the fluid-rock interaction can have a higher or lower intensity, altering the final shape of the treated fracture. Therefore, custom-tailoring of acid fracturing job design to specific well conditions may improve stimulation treatment results. To predict the end effect of the treatment, it is common to use mathematical modelling software that utilizes empirical formulas with experimentally obtained coefficients.

Stimulation treatments may be designed and performed with the aid of simulations to predict the effects of a particular treatment. An example transport simulation technique is disclosed in Mao S et al., “An Efficient Three-dimensional Multiphase Particle-in-cell Model for Proppant Transport in the Field Scale,” Unconventional Resources Technology Conference 462, 22-24 Jul. 2019. Mao et al. describe simulating the placement of proppant particles in three dimensions. However, the disclosed technique does not account for acid etching, consumption of acid or rock bending. In this application, Applicant discloses an improved modeling method that comprises adjusting/calibrating of the coefficients applicable to a particular well. It provides a higher level of model prediction accuracy than a “one-size fits-all” approach.

A more cost-effective approach for obtaining a visual model of stimulation design is to plot pore volume of acid to breakthrough against injection rates, with “breakthrough” being indicative of the desired wormhole formation. That is, with known porosity, formation type and other characteristics, a model may be constructed in which curves of different acid types illustrate how much acid is supplied before “breakthrough” is attained, depending on the injection rate of the acid. This breakthrough is the point at which pressure resistance to the stimulation fluid becomes substantially negligible due to the formation of channel-like wormhole(s) that allow for freer movement of fluid. Unfortunately, while cost-effective, the resultant modeling may be lacking in accuracy. Specifically, the optimal injection rate may vary from the model because the model may employ a linear function. In reality, the acid behavior upon injection during stimulation is a radial dispersion that is largely unaccounted for by the known modeling techniques. As a result, operators may receive a potentially inaccurate assessment concerning the optimal injection rate when designing the stimulation application.

There are several journal articles concerning the reaction rate of carbonates with acids. The authors of these papers applied the “parallel plate reactor” concept to quantify activation energy, reaction order and reaction rate constant. The method disclosed here utilizes the same approach; however, the disclosed method uses activation energy, reaction order, reaction rate constant and other fitting parameters in mathematical modelling software.
Barron, A. N., Hendrickson, A. R., and D. R. Wieland. “The Effect of Flow on Acid Reactivity in a Carbonate Fracture.” J Pet Technol 14 (1962): 409-415.
Harris, O. E., Hendrickson, A. R., and A. W. Coulter. “High-Concentration Hydrochloric Acid Aids Stimulation Results in Carbonate Formations.” J Pet Technol 18 (1966): 1291-1296.
Nierode, D. E., and B. B. Williams. “Characteristics of Acid Reaction in Limestone Formations.” SPE J. 11 (1971): 406-418.
Roberts, L. D., Guin, J. A. “The Effect of Surface Kinetics in Fracture Acidizing.” SPE J. 14 (1974): 385-395.

The journal articles below may also provide a useful context to the ideas discussed herein.
L. F. Neumann, “Acid Fracturing: New Insights on Acid Etching Patterns from Experimental Investigation,” Society of Petroleum Engineers, pp. SPE-152179-MS, 2012.
C. Oeth, “Characterization of Small Scale Heterogeneity to Predict Acid Fracture Performance,” Society of Petroleum Engineers, pp. SPE-140336-MS, 2011.
J. Knox, “Fracture Acidizing In Carbonate Rock,” Petroleum Society of Canada, vol. 18, no. 04, pp. PETSOC-79-04-07, 1979.
M. Pournik, “Influence of Acid-Fracture Fluid Properties on Acid-Etched Surfaces and Resulting Fracture Conductivity,” Society of Petroleum Engineers, pp. SPE-128070-MS.
L. F. Neumann, “Building Acid Frac Conductivity in Highly-Confined Carbonates,” Society of Petroleum Engineers, pp. SPE-152164-MS, 2012.

In patent WO2020231383A1, an optimized centrifuge is used to study fluid-rock interaction properties. However, it is not mentioned that the extracted data may be coupled with simulator software that can leverage these optimized values. Moreover, the present disclosure employs fluid flow geometry that is closer to actual fracture conditions (parallel plate).

Patent application US20180238147A1 discloses optimization of the fracturing job on-the-fly (during the actual operation) based on the feedback of the formation to diverter slugs. The present disclosure is related to optimizations that are made during the preparation stage (fluid composition and design, based on the chemistry of fluid-rock interactions).

Patent application US20160160627A1 discloses optimization of a treatment based on tuning the simulator parameters and evaluating the outputs. However, the application does not claim optimization of fluid-rock interactions and/or acid fracturing treatments.

Patent U.S. Pat. No. 7,774,183B2 involves predicting treatment performance in self-diverting acid systems on the basis of flow parameters that are derived from core flood experiments; however, the disclosed methods do not employ complex simulator software.

### SUMMARY

The present invention discloses a method to improve hydraulic fracture conductivity by injecting sequences of fluids with compositions optimized for the local reservoir.

In an aspect, embodiments relate to methods for stimulating a subterranean well. A plurality of candidate stimulation treatments are provided that comprise injection of an acid-containing hydraulic fracturing fluid, wherein the candidate stimulation treatments are compatible with characteristics of the formation to be treated. For each of the candidate stimulation treatments, laboratory testing is performed to measure interactions between the acid-containing hydraulic fracturing fluid and the formation to be stimulated. The test results are entered into a computational model that calculates acid-containing fluid-formation interaction parameters. The interaction parameters are then used to design a hydraulic fracturing treatment that provides maximum well productivity. The designed hydraulic fracturing treatment is performed.

In a further aspect, embodiments relate to methods for treating a subterranean well. A plurality of candidate stimulation treatments are provided that comprise injection of an acid-containing hydraulic fracturing fluid, wherein the candidate stimulation treatments are compatible with characteristics of the formation to be treated. For each of the candidate stimulation treatments, laboratory testing is performed to measure interactions between the acid-containing hydraulic fracturing fluid and the formation to be stimulated. The test results are entered into a computational model that calculates acid-containing fluid-formation interaction parameters. The interaction parameters are then used to design a hydraulic fracturing treatment that provides maximum well productivity. The designed hydraulic fracturing treatment is performed.

### BRIEF DESCRIPTION OF THE DRAWINGS

FIG. 1 is a schematic view of a geological formation with a wellbore and a fracture.

FIG. 2 shows split cores employed during laboratory testing at reservoir conditions.

FIG. 3 is a flow chart describing the workflow of acquiring experimental split-core data and adjusting the reservoir stimulation model parameters accordingly.

FIG. 4 is a plot showing experimental and simulated results of acid etching tests with limestones and dolomites before adjustment of the computational model parameters.

FIG. 5 is a plot showing the effects of applying the adjusted computational model parameters.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific, it is to be understood that inventors appreciate and understand that any data points within the range are to be considered to have been specified, and that inventors possessed knowledge of the entire range and the points within the range.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

As used herein, the terms “treatment fluid,” “acidizing fluid” or “wellbore treatment fluid” are inclusive of “stimulating treatment” and should be understood broadly. These may be or include a liquid, a foam, a solid, a gas, and combinations thereof, as will be appreciated by those skilled in the art. A treatment fluid may take the form of a solution, an emulsion, slurry, or any other form as will be appreciated by those skilled in the art. It should be understood that, although a substantial portion of the following detailed description may be provided in the context of acidizing operations, other oilfield operations such as cementing, gravel packing, etc., or even non-oilfield well treatment operations, can utilize and benefit as well from the disclosure of the present methods of formation treatment.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

The present disclosure provides methods and apparatus for stimulating production from a formation such as a hydrocarbon-bearing formation. Such stimulation is effected by injection of pressurized fluid into the formation through a wellbore. The pressurized fluid may include proppant or channeling agents.

The acid-containing fluid is injected at a pressure sufficient to cause shifts within the formation. For example, the pressurized fluid may widen existing fractures or induce new fractures within the formation. Once the pressure is relieved, stress in the formation, referred to as closure stress tends to urge rock back to its original position. Proppant particles in the injected fluid may become lodged between adjacent rock surfaces at a fracture, so that the aperture between rock surfaces is held open against closure stress. This may be referred to as a propped fracture.

Acid in the injected fluid may also provide additional clearance between rock surfaces in the formation, for example, by etching the surfaces so that additional space remains after the fracturing pressure is relieved.

The effectiveness of these mechanisms and interaction between these mechanisms may depend on numerous factors, such as the type of rock and hydrocarbons in the formation, rock porosity, and pre-existing fracture geometry. Such factors, may for example, impact the flow of fracturing fluid through the formation, movement of proppant within the injected fluid, consumption of acid and extent of etching, closure stress and propped aperture size.

The success of a stimulation may be assessed in terms of the increase in conductivity of the formation or production from the formation, relative to the cost of the stimulation.

Therefore, in disclosed examples, a simulation is performed as part of a stimulation operation, in order to identify advantageous parameters for stimulation. Such parameters may include one or more injection locations, through which pressurized fluid will pass into the formation, injection pressures, pumping schedules, and fluid and proppant quantity and composition, among other factors.

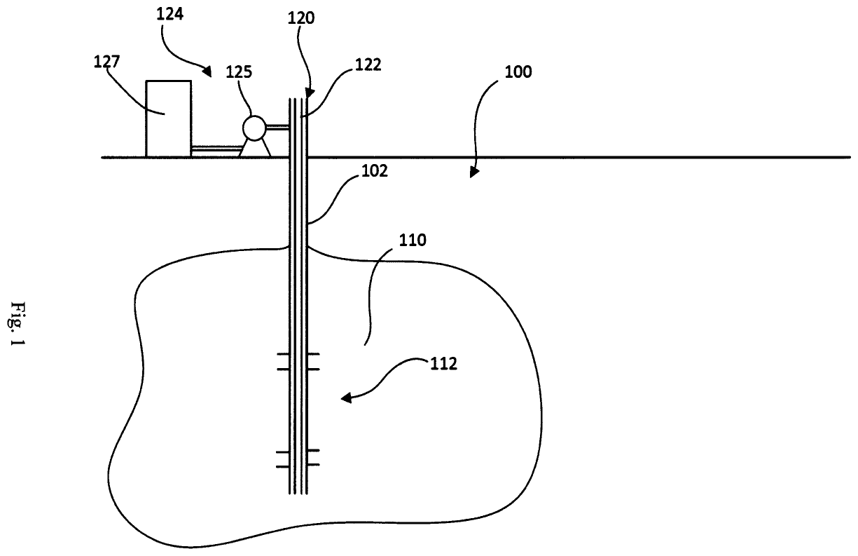

FIG. 1 is a simplified schematic view of a hydrocarbon-bearing formation 100, with a well bore 102 drilled within the formation for production of hydrocarbons.

Hydrocarbons within the formation 100 may pass through the formation to the well bore 102 through flow passages such as pores or fractures. The propensity of the formation to permit flow of hydrocarbons may be referred to as conductivity.

Pressurized fluid may be injected into formation 100 through wellbore 102. Such injection may cause the formation to shift and may induce fracturing. This may, in turn, lead to increased conductivity of the formation, and improved hydrocarbon production. This process is referred to as hydraulic fracturing.

As shown in FIG. 1, a fracture network exists within formation 100, surrounding wellbore 102. The fracture network includes fractures 110, which may be naturally occurring or artificially induced, e.g. by hydraulic fracturing. The fracture network may be approximately uniform, or may include concentrations of fractures 110 at one or more locations within the formation 100.

Hydrocarbons may likewise be distributed uniformly or non-uniformly throughout the formation 100. For example, hydrocarbons may be concentrated in one or more regions of the formation 100.

Hydrocarbons and other fluids may flow through fractures 110 in formation 100, as indicated by arrows 112. Fluid flow through the formation may be dependent, for example, on the number and size of fractures 110, distribution of fluids relative to the fractures, and pressure gradients within the formation.

Wellbore 102 extends from the surface into formation 100. A wellhead 120 is positioned at the surface, and a tubing string 122 extends from the wellhead 120, downwardly within wellbore 102 along the length of the wellbore.

A pumping system 124 is provided at the surface, in communication with tubing string 122 by way of the wellhead 120, for pumping fluid under pressure into tubing string 122.

Tubing string 122 has one or more injection ports 126 positioned along its length. Injection ports 126 are openings in at which the interior of tubing string 122 communicates with formation 100, so that pressurized fluid can pass from tubing string 122 into formation 100. Injection ports 126 may be controllable. That is, injection ports may be selectively opened, such that injection of pressurized fluid into formation 100 need not simultaneously occur at all ports 126.

Pumping system 124 includes one or more surface pumps 125 and one or more fracturing fluid reservoirs 127. Components of pumping system 124 may be positioned on trucks or other movable platforms.

Within this framework, the present disclosure presents methods for improving hydraulic fracture conductivity and well productivity by injecting sequences of fluids with compositions that are appropriate for the reservoir being treated.

In an aspect, embodiments relate to methods for stimulating a subterranean well. A plurality of candidate stimulation treatments are provided that comprise injection of an acid-containing hydraulic fracturing fluid, wherein the candidate stimulation treatments are compatible with characteristics of the formation to be treated. For each of the candidate stimulation treatments, laboratory testing is performed to measure interactions between the acid-containing hydraulic fracturing fluid and the formation to be stimulated. The test results are entered into a computational model that calculates acid-containing fluid-formation interaction parameters. The interaction parameters are then used to design a hydraulic fracturing treatment that provides maximum well productivity. The designed hydraulic fracturing treatment is performed.

In a further aspect, embodiments relate to methods for treating a subterranean well. A plurality of candidate stimulation treatments are provided that comprise injection of an acid-containing hydraulic fracturing fluid, wherein the candidate stimulation treatments are compatible with characteristics of the formation to be treated. For each of the candidate stimulation treatments, laboratory testing is performed to measure interactions between the acid-containing hydraulic fracturing fluid and the formation to be stimulated. The test results are entered into a computational model that calculates acid-containing fluid-formation interaction parameters. The interaction parameters are then used to design a hydraulic fracturing treatment that provides maximum well productivity. The designed hydraulic fracturing treatment is performed.

Key differentiators of the present disclosure may include the following.
1. Using reservoir-specific conditions together with custom-tailored fluids to address the stimulation challenges in each particular situation. This is achieved by joint testing of proposed designs with the hydraulic fracturing simulator together with physical testing of given reservoir rock with actual stimulation fluids under conditions mimicking the actual job.
2. Fitting the kinetics and diffusion coefficients for the fluid-rock interaction with use of the same software that is employed to model the stimulation job. This ensures that all the extracted parameters are working as expected, as the same simulator engine is engaged to produce the fitting coefficients on lab data and then using those coefficients on real reservoir data. Details concerning the model and simulations may be found in the following publication. Kuznetsov D et al.: “New Acid Fracturing Model on Reservoir-Centric Platform for Carbonate Formations,” paper IPTC-19818, presented at the International Petroleum Technology Conference, Dhahran, Saudi Arabia (2020).

The disclosed method may be performed as follows.
1. Obtaining log data and core samples from a reservoir that is planned as acid stimulation candidate.
2. Laboratory testing of fluid-rock interactions:
   Split-core testing under reservoir conditions with actual stimulation fluids, where the cores are representative of the actual reservoir rock
   Fitting the laboratory data to the acid fracturing model described in paper IPTC-19818, thereby obtaining fluid-rock interaction parameters specific to the given particular fluid-rock pairs
   Using the obtained parameters to design an appropriate acid treatment program. The testing may be repeated if needed to generate data with different fluid compositions.
3. Finalizing the treatment design with custom-tailored fluid compositions and parameters reflecting the fluid-rock interactions.
4. Estimating oil/gas production at initial and subsequent moments of time.

For both aspects, the laboratory testing may be conducted with core samples of the formation to be stimulated, or with synthetic cores that have properties equivalent to the formation to be stimulated.

For both aspects, the laboratory testing may be conducted under simulated reservoir conditions.

For both aspects, the core samples or synthetic cores may be split cores.

For both aspects, the injection of the hydraulic fracturing fluid may comprise initiating a fracture with a linear or crosslinked gel, followed by an acid that etches fracture surfaces.

For both aspects, the acid may comprise hydrochloric acid, hydrofluoric acid, formic acid or acetic acid, or combinations thereof.

For both aspects, the hydraulic fracturing fluid may further comprise proppants or channeling agents, or both.

For both aspects, the formation to be stimulated may comprise carbonates, sandstones or combinations thereof.

For both aspects, the carbonate minerals may comprise calcite, limestone, dolomite or combinations thereof.

### EXAMPLES

The following examples describe the split-core testing, performed in the laboratory under reservoir conditions.

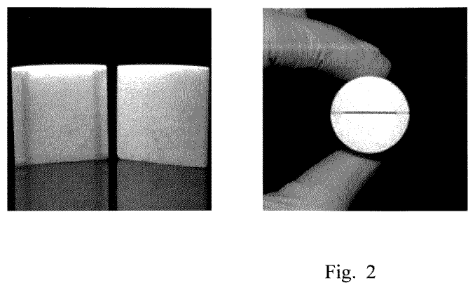

Adjustment of activation energy, reaction order, reaction rate constant and other fitting parameters that are utilized in the mathematical model, is conducted with HP-HT (high pressure-high temperature) apparatus that allows simulating downhole conditions. A cylinder of 1-12 inches in height and 1-2 inches in diameter is drilled out from the bulk core material. After measurement of initial permeability and porosity, the cylinder is cut in two halves along the axial direction. Then two metal shims/inserts were placed and fixed with a glue between these two parts of the core to mimic a formation fracture (FIG. 2). The size of the shims/inserts defines the size of the fracture (area and width).

After assembling a split-core, it is placed in inside a Hassler sleeve. By means of a dedicated pump and a heater band, the split-core is subjected to confining pressure and temperature. In turn, an acid-based treatment fluid is placed in a separate vessel (accumulator) that is also equipped with the heater band. After the temperature in the core-holder and accumulator stabilizes at the target value, the treatment fluid is displaced from the accumulator and into a pipeline that reaches an annulus of the split-core. When the acid enters the annulus it reacts with the surface, resulting in the surface etching. The fluid flows through the split-core at a certain flow rate. Several experiments may be required to cover a range of the flow rates that represents fluid velocities in the real fracture. To suppress CO₂ bubbling and increase CO₂ solubility in the treatment fluid, the back pressure is set at 1150-1200 psi.

After pumping of the acid is stopped, the split-core is extracted from the Hassler sleeve and rinsed with deionized water to stop the reaction. Then the split-core is disassembled. Etched width and active area that was subsequently subjected to an acid treatment is measured by means of laser profilometry.

Next, the split-core testing data are transferred into the model parameters, allowing a simulation of the treatment.

Test parameters that are transferred into the model may include: linear dimensions of the split core gap (width, length, height), information about the rock (lithology, porosity etc.) and the fluids (acid composition and concentration etc.), and test conditions (temperature, pressure, fluid flow rate etc.).

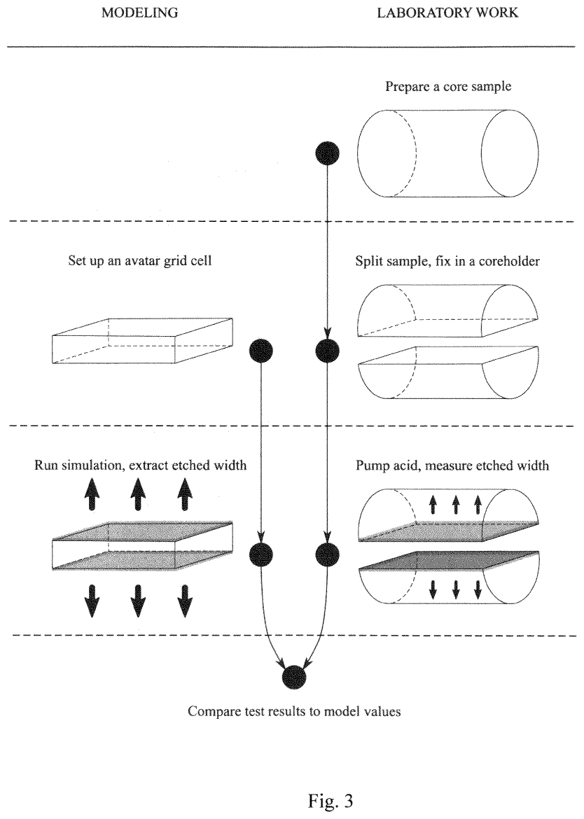

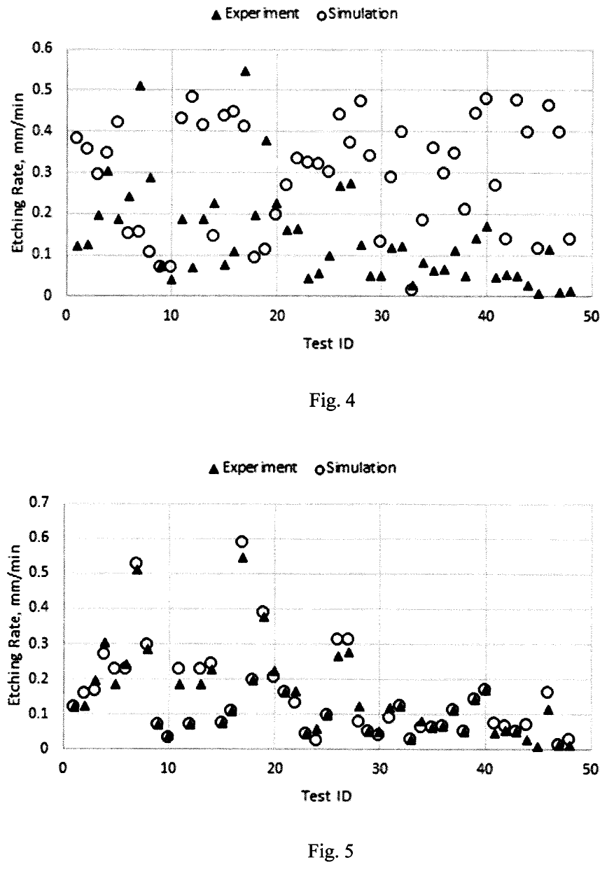

After the simulation is prepared to mimic the laboratory test, the simulation is performed to determine core sample mass loss, etched width value or similar measurements of etching intensity. These data may then be compared (FIG. 3), and the quality of current model fitting parameters can be assessed. Based on the result of the assessment, further actions may be determined that may include re-fitting, or setting default values for modeling interactions between a given rock and fluid.

The simulator uses the same engine as the principal acid fracturing model, and is used to determine appropriate fluid-rock interaction parameters. Such parameters include but are not limited to properties of chemical reaction kinetics (reaction order, reference rate constant, energy of activation) and diffusion (coefficients in the effective diffusivity correlation, diffusion retardation factor).

The adjusted parameters ensure an appropriate fit to the laboratory data set regardless of its size, therefore providing good quality of simulation. Good quality of simulation is the baseline of correct production prediction; therefore, using the technique in the current disclosure allows production in the well to be simulated based on maximized customization of the proposed design.

### Example 1

Differences in chemical composition of reservoir rocks might have may lead to different rates of reaction between a stimulation acid and the rock. To address the risks associated with such changes, parameters tuning based on the present disclosure may help. The kinetic parameters to tune in this case may include (but are not limited to) rate constants, reaction orders, activation energies, etc.

A series of etching experiments was performed with limestone and dolomite cores, stimulated by plain hydrochloric acid or by retarded hydrochloric acid. The retarded acid contained 20 wt % MgCl₂. The rock types, acid types, acid concentrations, pumping rates, pumping times, and experimentally measured and simulated etching rates are presented in Table 1.

TABLE 1
Acid etching experiments with limestone and dolomite.

| | | | | | | | Experimentally | |
|---|---|---|---|---|---|---|---|---|
| | | | Acid | | Pumping | Pumping | measured | Simulated |
| Test | | | Concentration, | Temperature, | rate, | Time, | Etching Rate, | Etching Rate, |
| ID | Rock Type | Acid Type | % | ° C. | mL/min | min | mm/min | mm/min |
| 1 | Limestone | plain HCl | 15 | 30 | 1 | 10 | 0.120606633 | 0.162440683 |
| 2 | Limestone | plain HCl | 15 | 30 | 10 | 30 | 0.123295179 | 0.123295179 |
| 3 | Limestone | plain HCl | 15 | 30 | 30 | 10 | 0.19538487 | 0.172365934 |
| 4 | Limestone | plain HCl | 5 | 30 | 10 | 10 | 0.30390607 | 0.329022332 |
| 5 | Limestone | plain HCl | 5 | 30 | 30 | 10 | 0.185518122 | 0.221600859 |
| 6 | Limestone | plain HCl | 5 | 30 | 1 | 30 | 0.241658966 | 0.241658966 |
| 7 | Limestone | plain HCl | 28 | 30 | 10 | 5 | 0.510475661 | 0.540549886 |
| 8 | Limestone | plain HCl | 28 | 30 | 30 | 5 | 0.286609771 | 0.286609771 |
| 9 | Limestone | plain HCl | 28 | 30 | 1 | 10 | 0.07102579 | 0.098588709 |
| 10 | Limestone | retarded HCl | 15 | 30 | 10 | 14 | 0.038867138 | 0.038867138 |
| 11 | Limestone | retarded HCl | 15 | 30 | 30 | 5 | 0.185401169 | 0.185401169 |
| 12 | Limestone | retarded HCl | 15 | 30 | 1 | 20 | 0.068985973 | 0.068985973 |
| 13 | Limestone | plain HCl | 15 | 60 | 1 | 10 | 0.18635901 | 0.146360289 |
| 14 | Limestone | plain HCl | 15 | 60 | 30 | 5 | 0.226593138 | 0.184034978 |
| 15 | Limestone | plain HCl | 15 | 60 | 10 | 5 | 0.074960086 | 0.11610591 |
| 16 | Limestone | plain HCl | 15 | 60 | 30 | 5 | 0.109055891 | 0.109055891 |
| 17 | Limestone | retarded HCl | 15 | 60 | 30 | 5 | 0.546638953 | 0.572841831 |
| 18 | Limestone | retarded HCl | 15 | 60 | 1 | 10 | 0.197017558 | 0.245149926 |
| 19 | Limestone | retarded HCl | 15 | 60 | 10 | 10 | 0.378136547 | 0.415570625 |
| 20 | Limestone | retarded HCl | 15 | 60 | 10 | 10 | 0.224686264 | 0.244606453 |
| 21 | Dolomite | plain HCl | 15 | 60 | 10 | 30 | 0.160556272 | 0.182785815 |
| 22 | Dolomite | plain HCl | 15 | 60 | 30 | 30 | 0.164540533 | 0.161065206 |
| 23 | Dolomite | plain HCl | 28 | 60 | 10 | 20 | 0.044814378 | 0.044814378 |
| 24 | Dolomite | plain HCl | 28 | 60 | 1 | 60 | 0.05758481 | 0.055868891 |
| 25 | Dolomite | plain HCl | 5 | 60 | 10 | 40 | 0.098459431 | 0.098459431 |
| 26 | Dolomite | plain HCl | 5 | 60 | 1 | 120 | 0.266057966 | 0.291337372 |
| 27 | Dolomite | plain HCl | 5 | 60 | 30 | 20 | 0.275536821 | 0.307343146 |
| 28 | Limestone | plain HCl | 15 | 90 | 10 | 2 | 0.123971536 | 0.078271217 |
| 29 | Limestone | plain HCl | 15 | 90 | 1 | 2 | 0.049676924 | 0.041064016 |
| 30 | Limestone | plain HCl | 5 | 90 | 10 | 5 | 0.051035278 | 0.034293799 |
| 31 | Limestone | plain HCl | 5 | 90 | 1 | 10 | 0.118952406 | 0.11468538 |
| 32 | Limestone | plain HCl | 5 | 90 | 30 | 5 | 0.12205837 | 0.091683819 |
| 33 | Limestone | plain HCl | 28 | 90 | 1 | 10 | 0.026529159 | 0.026529159 |
| 34 | Limestone | retarded HCl | 15 | 90 | 30 | 2 | 0.080965194 | 0.075438712 |
| 35 | Limestone | retarded HCl | 15 | 90 | 10 | 5 | 0.063801706 | 0.084157818 |
| 36 | Dolomite | plain HCl | 15 | 90 | 10 | 2 | 0.067117908 | 0.067117908 |
| 37 | Dolomite | plain HCl | 15 | 90 | 10 | 10 | 0.110795437 | 0.133228396 |
| 38 | Dolomite | plain HCl | 15 | 90 | 1 | 15 | 0.051263866 | 0.051263866 |
| 39 | Dolomite | plain HCl | 15 | 90 | 1 | 30 | 0.141787149 | 0.158933822 |
| 40 | Dolomite | plain HCl | 15 | 90 | 30 | 5 | 0.171357719 | 0.171357719 |
| 41 | Dolomite | plain HCl | 28 | 90 | 10 | 10 | 0.047140377 | 0.00928419 |
| 42 | Dolomite | plain HCl | 28 | 90 | 1 | 30 | 0.054320943 | 0.064059751 |
| 43 | Dolomite | plain HCl | 15 | 90 | 10 | 20 | 0.050595101 | 0.050595101 |
| 44 | Dolomite | plain HCl | 15 | 90 | 1 | 30 | 0.028486304 | 0.028486304 |
| 45 | Dolomite | plain HCl | 15 | 90 | 30 | 5 | 0.008361792 | 0.017960132 |
| 46 | Dolomite | plain HCl | 5 | 90 | 10 | 30 | 0.114645739 | 0.136570377 |
| 47 | Dolomite | plain HCl | 5 | 90 | 1 | 60 | 0.012028837 | 0.002458219 |
| 48 | Dolomite | plain HCl | 5 | 90 | 30 | 15 | 0.014350993 | 0.062978651 |

The experimentally measured and simulated etching rates are presented in FIG. 5. These data were then entered into the presently disclosed computational model that considers the aforementioned parameters (i.e., chemical reaction kinetics (reaction order, reference rate constant, energy of activation) and diffusion (coefficients in the effective diffusivity correlation, diffusion retardation factor)). The results are presented in FIG. 6. It is evident that the computational model improved agreement between the experimental and simulated results.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

1. A method for stimulating a subterranean well, comprising:
a. providing a plurality of candidate stimulation treatments comprising injection of an acid-containing hydraulic fracturing fluid, wherein the candidate stimulation treatments are compatible with characteristics of a formation to be treated;
b. for each one of the candidate stimulation treatments:
i. performing laboratory testing to measure interactions between the acid-containing hydraulic fracturing fluid and the formation to be stimulated;
ii. entering results of the laboratory testing into a computational model that calculates acid-containing fluid-formation interaction parameters; and
iii. using the interaction parameters to design a hydraulic acid fracturing treatment that provides maximum well productivity; and
c. performing the hydraulic acid fracturing treatment that provides maximum well productivity.

2. The method of claim 1, further comprising determining the characteristics of the formation to be stimulated.

3. The method of claim 1, wherein the acid-containing fluid-formation interaction parameters comprise chemical reaction kinetics and diffusion.

4. The method of claim 1, wherein the laboratory testing is conducted with split-core plugs of the formation to be acid stimulated, or with synthetic cores that have properties equivalent to the formation to be acid stimulated.

5. The method of claim 1, wherein the laboratory testing is conducted under simulated reservoir conditions.

6. The method of claim 1, wherein the injection of the acid-containing hydraulic fracturing fluid comprises initiating a fracture with a linear or crosslinked gel, followed by an acid that etches fracture surfaces.

7. The method of claim 6, wherein the acid comprises hydrochloric acid, hydrofluoric acid, formic acid or acetic acid, or combinations thereof.

8. The method of claim 1, wherein the acid-containing hydraulic fracturing fluid further contains proppants or channeling agents.

9. The method of claim 1, wherein the formation to be stimulated comprises carbonates, sandstones or combinations thereof.

10. The method of claim 9, wherein the carbonates comprise calcite, limestone or dolomite, or combinations thereof.

11. A method for treating a subterranean well, comprising:
a. providing a plurality of candidate treatments comprising injection of an acid containing hydraulic fracturing fluid, wherein the candidate treatments are compatible with characteristics of a formation to be treated;
b. for each one of the candidate treatments:
i. performing laboratory testing to measure interactions between the acid-containing hydraulic fracturing fluid and the formation to be stimulated;
ii. entering results of the laboratory testing into a computational model that calculates acid-containing fluid-formation interaction parameters; and
iii. using the interaction parameters to design a hydraulic acid fracturing treatment that provides maximum well productivity; and
c. performing the hydraulic acid fracturing treatment that provides maximum well productivity.

12. The method of claim 11, further comprising determining the characteristics of the formation to be stimulated.

13. The method of claim 11, wherein the acid-containing fluid-formation interaction parameters comprise chemical reaction kinetics and diffusion.

14. The method of claim 11, wherein the laboratory testing is conducted with split-core plugs of the formation to be acid stimulated, or with synthetic cores that have properties equivalent to the formation to be acid stimulated.

15. The method of claim 11, wherein the laboratory testing is conducted under simulated reservoir conditions.

16. The method of claim 11, wherein the injection of the acid-containing hydraulic fracturing fluid comprises initiating a fracture with a linear or crosslinked gel, followed by an acid that etches fracture surfaces.

17. The method of claim 16, wherein the acid comprises hydrochloric acid, hydrofluoric acid, formic acid or acetic acid, or combinations thereof.

18. The method of claim 11, wherein the acid-containing hydraulic fracturing fluid further contains proppants or channeling agents.

19. The method of claim 11, wherein the formation to be stimulated comprises carbonates, sandstones or combinations thereof.

20. The method of claim 19, wherein the carbonates comprise calcite, limestone or dolomite, or combinations thereof.
